(19) United States
(12) Patent Application Publication
(10) Pub. No.: US 2022/0245777 A1
(43) Pub. Date: Aug. 4, 2022

(54) IMAGE PROCESSING METHOD, APPARATUS AND DEVICE AND COMPUTER-READABLE STORAGE MEDIUM

(71) Applicant: MEGVII (BEIJING) TECHNOLOGY CO., LTD., Beijing (CN)

(72) Inventors: Jianghu LU, Beijing (CN); Cong YAO, Beijing (CN)

(21) Appl. No.: 17/612,750

(22) PCT Filed: May 19, 2020
(86) PCT No.: PCT/CN2020/091046

§ 371 Date: Nov. 19, 2021

(30) Foreign Application Priority Data
Jun. 27, 2019 (CN) 201910570341.5

(51) Int. Cl. G06T 5/50; G06V 10/50; G06V 10/48; G06V 40/16; G06T 7/11

(52) U.S. Cl. CPC G06T 5/50; G06V 10/50; G06V 10/48; G06T 2207/20221; G06V 40/168; G06T 7/11; G06V 40/161

(57) ABSTRACT

An image processing method and apparatus, a device and a computer-readable storage medium, wherein the method includes: acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image.

The present application claims the priority of the Chinese patent application filed on Jun. 27, 2019 before the Chinese Patent Office with the application number of 201910570341.5 and the title of “IMAGE PROCESSING METHOD, APPARATUS AND DEVICE AND COMPUTER-READABLE STORAGE MEDIUM”, which is incorporated herein in its entirety by reference.

### TECHNICAL FIELD

The present application relates to the technical field of computers, and, particularly, the present application relates to an image processing method and apparatus, a device and a computer-readable storage medium.

### BACKGROUND

Along with the flourishing of the industry of live broadcasting and the rising of the technique of artificial intelligence, various beautifying algorithms run in real time with the cameras of live broadcasting, to beautify people. People have the demand on constructing a perfect himself in the network world, and desire to, by using existing source materials, quickly generate a source-material image (the target image) that is similar to both of the regions of a real-person image (the original image) and the real-person image as a whole, which should be beautiful and like the real person himself. Currently, all of the main approaches for beautification are buffing of the human face, or special effects to a certain extent, which have a poor effect of beautification.

### SUMMARY

In order to overcome the disadvantages of the conventional solutions, the present application provides an image processing method and apparatus, a device and a computer-readable storage medium, to solve the problem how to quickly enable the target image and the original image to be very similar both as a whole and in the regions, which results in the effect of beautification.

In a first aspect, the present application provides an image processing method, wherein the method comprises:

acquiring a plurality of critical points of regions of an original image, wherein the regions correspond to different body parts in a portrait;

according to the plurality of critical points of the regions, determining shape-context-histogram features of the regions of the original image;

according to the shape-context-histogram features of the regions of the original image and shape-context-histogram features of predetermined source-material region images of corresponding regions, determining a plurality of cost matrixes for the regions;

according to the plurality of cost matrixes for the regions, screening source-material region images that match with each of the regions of the original image from the source-material region images; and

splicing the source-material region images that match with each of the regions of the original image, to obtain a target image corresponding to the original image.

In a second aspect, the present application provides an image processing apparatus, wherein the apparatus comprises:

a first processing module configured for acquiring a plurality of critical points of regions of an original image, wherein the regions correspond to different body parts in a portrait;

a second processing module configured for, according to the plurality of critical points of the regions, determining shape-context-histogram features of the regions of the original image;

a third processing module configured for, according to the shape-context-histogram features of the regions of the original image and shape-context-histogram features of predetermined source-material region images of corresponding regions, determining a plurality of cost matrixes for the regions;

a fourth processing module configured for, according to the plurality of cost matrixes for the regions, screening source-material region images that match with each of the regions of the original image from the source-material region images; and

a fifth processing module configured for splicing the source-material region images that match with each of the regions of the original image, to obtain a target image corresponding to the original image.

In a third aspect, the present application provides an electronic device, wherein the electronic device comprises a processor, a memory and a bus;

the bus is configured for connecting the processor and the memory;

the memory is configured for storing an operation instruction; and

the processor is configured for, by invoking the operation instruction, implementing the image processing method according to the first aspect of the present application.

In a fourth aspect, the present application provides a computer-readable storage medium, wherein the computer-readable storage medium stores a computer program, and the computer program is configured for implementing the image processing method according to the first aspect of the present application.

The technical solutions according to the embodiments of the present application have at least the following advantageous effects:

The present application, by acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image, realizes the quick matching of the regions of the original image with the corresponding source-material region images, and, by splicing the matched source-material region images, enables the obtained target image and the original image to be very similar both as a whole and in the regions, which results in the effect of beautification, and significantly improves the user experience.

The additional aspects and advantages of the present application will be given in the following description, and they will become apparent from the following description or be known from the implementation of the present application.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present application, the figures that are required to describe the embodiments of the present application will be briefly introduced below.

FIG. 1 is a schematic flow chart of the image processing method according to an embodiment of the present application;

FIG. 2 is a schematic flow chart of the image processing method according to another embodiment of the present application;

FIG. 3 is a schematic structural diagram of the image processing apparatus according to an embodiment of the present application; and

FIG. 4 is a schematic structural diagram of the electronic device according to an embodiment of the present application.

### DETAILED DESCRIPTION

The embodiments of the present application will be described in detail below, and the examples of the embodiments are illustrated in the drawings, wherein the same or similar reference numbers throughout the drawings indicate the same or similar elements or elements having the same or similar functions. The embodiments described below with reference to the drawings are exemplary, are merely intended to interpret the present application, and should not be construed as a limitation on the present application.

A person skilled in the art can understand that, unless stated specifically, the singular forms “a”, “an”, “the” and “said” used herein may also include the plural forms. It should be further understood that the expression “comprise” as used in the description of the present application refers to the existence of the described features, integers, steps, operations, elements and/or components, but does not exclude the existence or the addition of one or more other features, integers, steps, operations, elements and components and/or a group thereof. It should be understood that, when an element is described as being “connected” or “coupled” to another element, it may be directly connected or coupled to the another element, or there may also be an intermediate element. Moreover, the “connection” or “coupling” used herein may include wireless connection or wireless coupling. The expression “and/or” used herein includes all or any of the units of one or more related listed items and all of the combinations thereof.

A person skilled in the art can understand that, unless defined otherwise, all of the terms used herein (including technical terminologies and scientific terminologies) have the meanings that are the same as those generally understood by a person skilled in the art that the present application relates to. It should also be understood that those terms such as defined in a generic dictionary should be understood as having the meanings consistent with the meanings in the context of the prior art, and, unless specifically defined as used herein, should not be interpreted as having an idealized or too formal meaning.

It will be described in detail below with reference to the particular embodiments what the technical solutions of the present application are and how the technical solutions of the present application solve the above technical problems. The following particular embodiments may be combined with each other, and the same or similar concepts or processes may not be discussed repeatedly in some of the embodiments. The embodiments of the present application will be described below with reference to the drawings.

### The First Embodiment

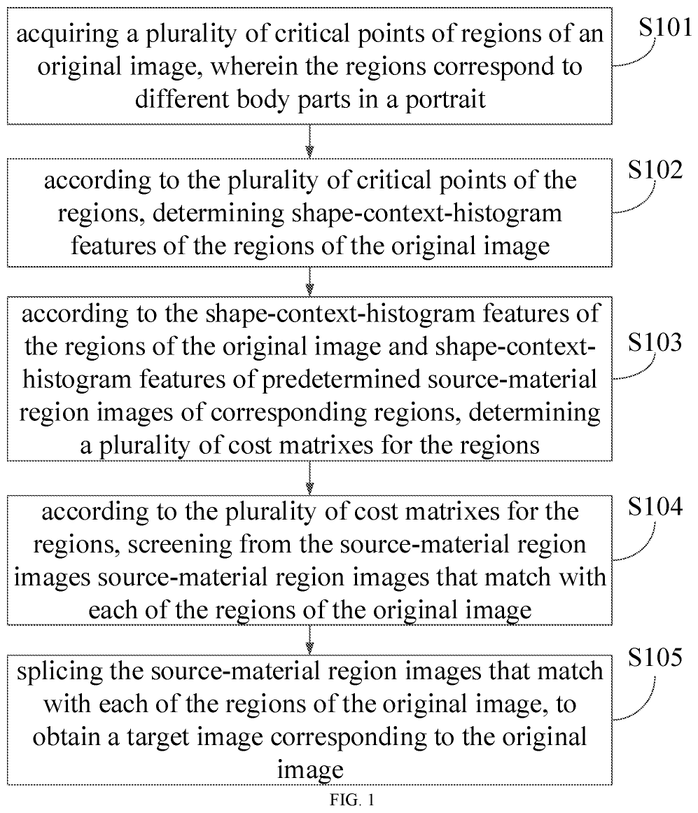

An embodiment of the present application provides an image processing method. A schematic flow chart of the method is shown in FIG. 1. The method comprises:

S101: acquiring a plurality of critical points of regions of an original image, wherein the regions correspond to different body parts in a portrait.

Optionally, the regions may be the face-organ regions of the original image, for example, an eye region, an eyebrow region and a two-eye region, and may also be a hair region. The plurality of critical points are located on the outlines of the corresponding regions.

Optionally, when the regions of the original image are face-organ regions of the original image, the step of acquiring the plurality of critical points of the regions of the original image comprises:

acquiring a plurality of dense critical points of the original image;

classifying the plurality of dense critical points of the original image, to obtain a plurality of dense critical points of each of the face-organ regions of the original image; and

sampling the plurality of dense critical points of each of the face-organ regions of the original image, to obtain a plurality of critical points of each of the face-organ regions of the original image obtained after the sampling. By using the dense critical points to extract the outlines of the organs, and performing effective sampling, sparse but complete organ outlines are obtained, which reduces the time complexity of the subsequent matching.

Optionally, the dense critical points are an upgrade of the regular critical points. The face of one person has 81 or 106 regular critical points, and the face of one person has 1000 dense critical points. All of the face organs have the dense critical points of different quantities. For example, the outline of the face has 273 dense critical points, the outline of the eyebrow region has 64 dense critical points, and the outline of the two-eye region has 63 dense critical points.

Optionally, the dense critical points of the face of a person are classified, to obtain the dense critical points of each of the local organs of the face, for example, the dense critical points on the outline of a left-eyebrow region, and the dense critical points on the outline of the left-eyebrow region are effectively sampled to a preset quantity, wherein the quantity is a first numerical value.

Optionally, the shape-context-histogram features of the source-material region images are saved into a high-performance key-value database Redis for inquiry. The types of the key values supported by Redis include a String character type, a map hash type, a List list type, a Set set type and a Sortedset sorted set type.

Optionally, the outline of the eyebrow region has 64 dense critical points, but the outline of the eyebrow region in the high-performance key-value database Redis has merely 30 regular critical points. Therefore, it is required to sample the 64 dense critical points on the outline of the eyebrow region, to obtain 30 dense critical points. Accordingly, the quantity of the 30 dense critical points on the outline of the eyebrow region and the quantity of the 30 regular critical points on the outline of the eyebrow region in the high-performance key-value database Redis are equal, and the first numerical value is 30.

Optionally, when one of the regions of the original image is a hair region of the original image, the step of acquiring the plurality of critical points of the regions of the original image comprises:

acquiring a grayscale map of the hair region of the original image;

according to the grayscale map of the hair region of the original image, determining an outline of the hair region of the original image; and

sampling the outline of the hair region of the original image, to obtain a plurality of regional critical points of the hair region of the original image.

S102: according to the plurality of critical points of the regions, determining shape-context-histogram features of the regions of the original image.

Optionally, this step comprises inputting the plurality of critical points of each of the face-organ regions of the original image and a plurality of regional critical points of a hair region of the original image into a predetermined shape-context-vector extractor, and performing shape-context-histogram-feature extraction, to obtain shape-context-histogram features of each of the face-organ regions of the original image and shape-context-histogram features of the hair region of the original image.

Optionally, the predetermined shape-context-vector extractor extracts one vector for one critical point in the region, wherein that vector represents that critical point, and a region is represented by the shape-context-histogram features including the plurality of vectors that are extracted by the predetermined shape-context-vector extractor. The shape-context-histogram feature is a method for describing features based on the outline of a shape, and it describes shape features by using a histogram in a logarithmic polar coordinate system, which can excellently reflect the distribution of the sample points on the outline.

S103: according to the shape-context-histogram features of the regions of the original image and shape-context-histogram features of predetermined source-material region images of corresponding regions, determining a plurality of cost matrixes for the regions.

Optionally, the source-material region image is a cartoon source material that is designed for each of the organs of the human body, for example, the cartoon source material of the eyebrow, the nose or the mouth, or a cartoon source material that is designed for the human hair. The shape-context-histogram features of the predetermined source-material region images are stored in the high-performance key-value database Redis, and the predetermined source-material region images are inquired and used from the high-performance key-value database Redis. One of the regions of the original image is the eyebrow, and the predetermined cartoon source material of the corresponding region is also the eyebrow.

Optionally, the Chi-square distances between each of the critical points of the face-organ regions and each of the critical points of the source-material regions may be obtained, whereby COST cost matrixes can be formed, wherein each of the elements of the cost matrixes represents the Chi-square distance between a certain critical point of the face-organ regions and a certain critical point of the source-material regions. The Chi-square distance is used to measure the difference between a certain critical point of the face-organ regions and a certain critical point of the source-material regions.

Optionally, this step comprises, according to the shape-context-histogram features of each of the face-organ regions of the original image, the shape-context-histogram features of the hair region of the original image and the shape-context-histogram features of the predetermined source-material region images of the corresponding regions, by using Chi-square-distance calculation, obtaining a plurality of cost matrixes for each of the face-organ regions of the original image and a plurality of cost matrixes for the hair region of the original image, wherein the predetermined source-material region images include face-organ source-material images and a hair source-material image, and each of elements of the cost matrixes characterizes a Chi-square distance between one of the critical points of the regions and one of the critical points of one of the source-material region images of the corresponding regions.

S104: according to the plurality of cost matrixes for the regions, screening source-material region images that match with each of the regions of the original image from the source-material region images.

Optionally, this step comprises, according to N cost matrixes corresponding to any one of the regions of the original image, matching each of the critical points of the any one of the regions with a critical point in a predetermined any one of the source-material region images that has a minimum Chi-square distance to the each of the critical points, summing the minimum Chi-square distances corresponding to all of the critical points of the any one of the regions as a cost value between the any one of the regions and the any one of the source-material region images, to obtain N cost values between the any one of the regions and predetermined N source-material region images, wherein N is a positive integer, and using a source-material region image corresponding to a minimum cost value among the N cost values as the source-material region image that matches with the any one of the regions.

Optionally, according to N cost matrixes corresponding to any one of the face-organ regions of the original image, by using a Hungarian Hungarian algorithm, N first cost values between the any one of the face organs and predetermined N face-organ source-material region images are obtained, wherein N is a positive integer, and the face-organ source-material region image corresponding to the minimum first cost value among the N first cost values is used as the source-material region image that matches with the any one of the face organs.

Optionally, according to M cost matrixes corresponding to the hair region of the original image, by using a Hungarian Hungarian algorithm, M second cost values between the hair region of the original image and predetermined M hair source-material region images are obtained, wherein M is a positive integer, and the hair source-material region image corresponding to the minimum second cost value among the M second cost values is used as the source-material region image that matches with the hair of the original image.

S105: splicing the source-material region images that match with each of the regions of the original image, to obtain a target image corresponding to the original image.

Optionally, the source-material region images that match with each of the regions of the original image are spliced according to the positions of the corresponding regions in the original image, to obtain a target image corresponding to the original image.

Optionally, the way of determining the shape-context-histogram features of the predetermined source-material region images comprises:

acquiring the source-material region images;

by using an alpha channel, extracting outlines of the source-material region images;

sampling the outlines of the source-material region images, to determine a plurality of critical points of the source-material region images; and

inputting the plurality of critical points of the source-material region images into a predetermined shape-context-vector extractor, and performing shape-context-histogram-feature extraction, to obtain the shape-context-histogram features of the predetermined source-material region images.

Optionally, the alpha channel is a 8-bit grayscale channel, and the channel uses 256-degrade grayscales to record the transparency information of images, to define a transparent region, a non-transparent region and a semitransparent region, wherein white represents a non-transparent region, black represents a transparent region and gray represents a semitransparent region.

Optionally, the source material is a cartoon source material, and the step of splicing the source-material region images that match with each of the regions of the original image, to obtain the target image corresponding to the original image comprises:

splicing cartoon-source-material region images that match with each of the regions of the original image, to obtain a cartoon image corresponding to the original image.

Optionally, for each of the organs of the human body, for example, the eyebrow, the nose and the mouth, and the hair, many cartoon source materials have already been designed. For an inputted real-person image, the mostly similar cartoon source materials are searched for from a source-material database, and those mostly similar cartoon source materials are spliced together, to obtain a cartoonlized person image. The cartoonlized person image has a high similarity to the image of the real person.

The embodiment of the present application, by acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image, realizes the quick matching of the regions of the original image with the corresponding source-material region images, and, by splicing the matched source-material region images, enables the obtained target image and the original image to be very similar both as a whole and in the regions, which results in the effect of beautification, and significantly improves the user experience.

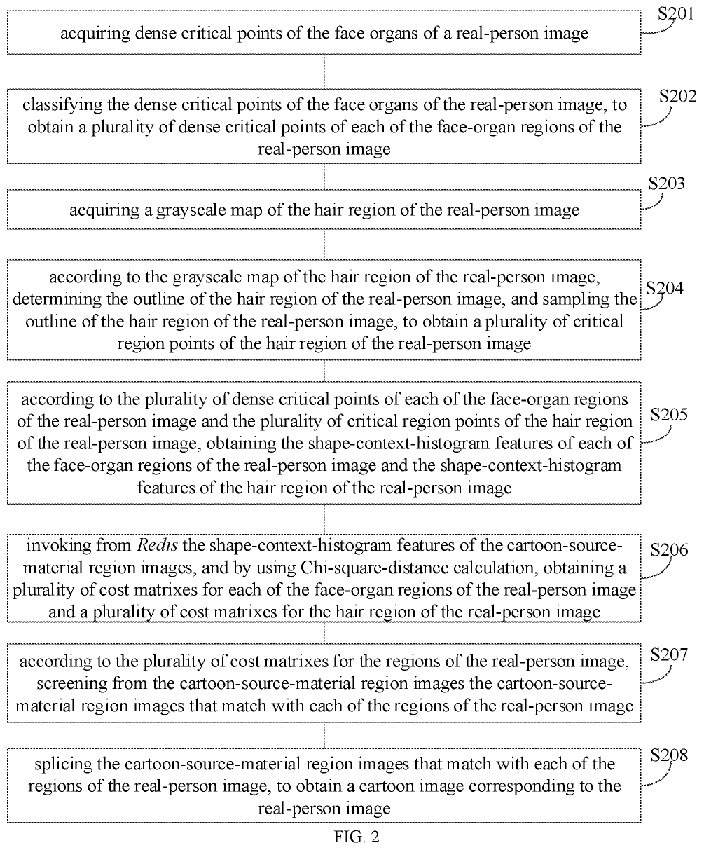

An embodiment of the present application provides another image processing method. A schematic flow chart of the method is shown in FIG. 2. The method comprises:

S201: acquiring dense critical points of the face organs of a real-person image.

Optionally, the original image is a real-person image. The dense critical points are an upgrade of the regular critical points. The face organs of one person have 81 or 106 regular critical points, and the face organs of one person have 1000 dense critical points. All of the face organs have the dense critical points of different quantities. For example, the outline of the face among the face organs has 273 dense critical points, the outline of the eyebrow region among the face organs has 64 dense critical points, and the outline of the two-eye region among the face organs has 63 dense critical points.

S202: classifying the dense critical points of the face organs of the real-person image, to obtain a plurality of dense critical points of each of the face-organ regions of the real-person image.

Optionally, the dense critical points of the face organs of a person are classified, to obtain the dense critical points of each of the face-organ regions of the face organs, for example, the dense critical points on the outline of a left-eyebrow region, and the dense critical points on the outline of the left-eyebrow region are effectively sampled to a preset quantity, wherein the quantity is a first numerical value.

Optionally, the shape-context-histogram features of the cartoon-source-material region images are saved into a high-performance key-value database Redis for inquiry. The types of the key values supported by Redis include a String character type, a map hash type, a List list type, a Set set type and a Sortedset sorted set type.

Optionally, the outline of the eyebrow region has 64 dense critical points, but the outline of the eyebrow region in the high-performance key-value database Redis has merely 30 regular critical points. Therefore, it is required to sample the 64 dense critical points on the outline of the eyebrow region, to obtain 30 dense critical points. Accordingly, the quantity of the 30 dense critical points on the outline of the eyebrow region and the quantity of the 30 regular critical points on the outline of the eyebrow region in the high-performance key-value database Redis are equal, and the first numerical value is 30.

S203: acquiring a grayscale map of the hair region of the real-person image.

S204: according to the grayscale map of the hair region of the real-person image, determining the outline of the hair region of the real-person image, and sampling the outline of the hair region of the real-person image, to obtain a plurality of regional critical points of the hair region of the real-person image.

S205: according to the plurality of dense critical points of each of the face-organ regions of the real-person image and the plurality of regional critical points of the hair region of the real-person image, obtaining the shape-context-histogram features of each of the face-organ regions of the real-person image and the shape-context-histogram features of the hair region of the real-person image.

Optionally, the plurality of dense critical points of each of the face-organ regions of the real-person image and the plurality of regional critical points of the hair region of the real-person image are inputted into a predetermined shape-context-vector extractor, and shape-context-histogram-feature extraction is performed, to obtain the shape-context-histogram features of each of the face-organ regions of the real-person image and the shape-context-histogram features of the hair region of the real-person image.

S206: invoking the shape-context-histogram features of the cartoon-source-material region images from Redis, and by using Chi-square-distance calculation, obtaining a plurality of cost matrixes for each of the face-organ regions of the real-person image and a plurality of cost matrixes for the hair region of the real-person image.

Optionally, this step comprises, for each of the parts of the real-person image, for example, the face-organ regions and the hair region, invoking the shape-context-histogram features of the cartoon-source-material region images from Redis, and, according to the shape-context-histogram features of each of the face-organ regions of the real-person image, the shape-context-histogram features of the hair region of the real-person image and the shape-context-histogram features of the cartoon-source-material region images of the corresponding regions, by using the Chi-square-distance formula (1), calculating the corresponding COST cost matrixes, wherein the formula (1) is shown as follows:

$${X}^{2} ( x , y ) = \sqrt{{\sum }_{i = 0}^{p} {( \frac{{x}_{t} - {Ex}_{t}}{{Ex}_{t}} )}^{2} + {\sum }_{i = 0}^{p} {( \frac{{y}_{t} - Ey}{{Ey}_{t}} )}^{2}} \qquad formula ( 1 )$$

wherein in the formula (1), x refers to the critical points that are represented by the vectors in the shape-context-histogram features of the cartoon-source-material region images, and y refers to the critical points that are represented by the vectors in the shape-context-histogram features of each of the face-organ regions of the real-person image or the shape-context-histogram features of the hair region of the real-person image. The Chi-square distances between each of the critical points of the face-organ regions and each of the critical points of the cartoon-source-material regions are obtained by using the formula (1), whereby COST cost matrixes can be formed, wherein each of the elements of the cost matrixes represents the Chi-square distance between a certain critical point of the face-organ regions and a certain critical point of the cartoon-source-material regions. The Chi-square distance is used to measure the difference between a certain critical point of the face-organ regions and a certain critical point of the cartoon-source-material regions.

S207: according to the plurality of cost matrixes for the regions of the real-person image, screening the cartoon-source-material region images that match with each of the regions of the real-person image from the cartoon-source-material region images.

Optionally, according to N cost matrixes corresponding to any one of the face-organ regions of the real-person image, by using a Hungarian Hungarian algorithm, N first cost values between the any one of the face organs and predetermined N face-organ cartoon-source-material region images are obtained, wherein for example, N is 10, and the face-organ cartoon-source-material region image corresponding to the minimum first cost value among the 10 first cost values is used as the cartoon-source-material region image that matches with the any one of the face organs. The different face organs may correspond to different preset quantities of the source materials, and the quantities of the obtained first cost values are also different. Each of the critical points of the face organs is matched with a critical point that has a minimum Chi-square distance to it in the face-organ source-material images, and the minimum Chi-square distances of all of the critical points are summed as the first cost value of the face organs and the face-organ source materials.

Optionally, according to M cost matrixes corresponding to the hair region of the real-person image, by using a Hungarian Hungarian algorithm, M second cost values between the hair region of the real-person image and predetermined M hair source-material region images are obtained, wherein for example, M is 10, and the hair cartoon-source-material region image corresponding to the minimum second cost value among the 10 second cost values is used as the cartoon-source-material region image that matches with the hair of the real-person image.

S208: splicing the cartoon-source-material region images that match with each of the regions of the real-person image, to obtain a cartoon image corresponding to the real-person image.

The embodiment of the present application has at least the following advantageous effects:

the embodiment of the present application realizes the quick matching of the regions of the original image of the real person with the corresponding cartoon-source-material region images, and, by splicing the matched cartoon-source-material region images, obtains the cartoon image corresponding to the original image of the real person, wherein the cartoon image and the original image of the real person are very similar both as a whole and in the regions, which results in the effect of beautification, and significantly improves the user experience.

### The Second Embodiment

On the basis of the same inventive concept, an embodiment of the present application further provides an image processing apparatus. A schematic structural diagram of the apparatus is shown in FIG. 3. The image processing apparatus 30 comprises a first processing module 301, a second processing module 302, a third processing module 303, a fourth processing module 304 and a fifth processing module 305.

The first processing module 301 is configured for acquiring a plurality of critical points of regions of an original image, wherein the regions correspond to different body parts in a portrait;

the second processing module 302 is configured for, according to the plurality of critical points of the regions, determining shape-context-histogram features of the regions of the original image;

the third processing module 303 is configured for, according to the shape-context-histogram features of the regions of the original image and shape-context-histogram features of predetermined source-material region images of corresponding regions, determining a plurality of cost matrixes for the regions;

the fourth processing module 304 is configured for, according to the plurality of cost matrixes for the regions, screening source-material region images that match with each of the regions of the original image from the source-material region images; and

the fifth processing module 305 is configured for splicing the source-material region images that match with each of the regions of the original image, to obtain a target image corresponding to the original image.

Optionally, when the regions of the original image are face-organ regions of the original image, the first processing module 301 is particularly configured for acquiring a plurality of dense critical points of the original image; classifying the plurality of dense critical points of the original image, to obtain a plurality of dense critical points of each of the face-organ regions of the original image; and sampling the plurality of dense critical points of each of the face-organ regions of the original image, to obtain a plurality of critical points of each of the face-organ regions of the original image obtained after the sampling.

Optionally, when one of the regions of the original image is a hair region of the original image, the first processing module 301 is particularly configured for acquiring a grayscale map of the hair region of the original image; according to the grayscale map of the hair region of the original image, determining an outline of the hair region of the original image; and sampling the outline of the hair region of the original image, to obtain a plurality of regional critical points of the hair region of the original image.

Optionally, the second processing module 302 is particularly configured for inputting the plurality of critical points of each of the face-organ regions of the original image and a plurality of regional critical points of a hair region of the original image into a predetermined shape-context-vector extractor, and performing shape-context-histogram-feature extraction, to obtain shape-context-histogram features of each of the face-organ regions of the original image and shape-context-histogram features of the hair region of the original image.

Optionally, the third processing module 303 is particularly configured for, according to the shape-context-histogram features of each of the face-organ regions of the original image, the shape-context-histogram features of the hair region of the original image and the shape-context-histogram features of the predetermined source-material region images of the corresponding regions, by using Chi-square-distance calculation, obtaining a plurality of cost matrixes for each of the face-organ regions of the original image and a plurality of cost matrixes for the hair region of the original image, wherein the predetermined source-material region images include face-organ source-material images and a hair source-material image, and each of elements of the cost matrixes characterizes a Chi-square distance between one of the critical points of the regions and one of the critical points of one of the source-material region images of the corresponding regions.

Optionally, the fourth processing module 304 is particularly configured for, according to N cost matrixes corresponding to any one of the regions of the original image, matching each of the critical points of the any one of the regions with a critical point in a predetermined any one of the source-material region images that has a minimum Chi-square distance to the each of the critical points, summing the minimum Chi-square distances corresponding to all of the critical points of the any one of the regions as a cost value between the any one of the regions and the any one of the source-material region images, to obtain N cost values between the any one of the regions and predetermined N source-material region images, wherein N is a positive integer, and using a source-material region image corresponding to a minimum cost value among the N cost values as the source-material region image that matches with the any one of the regions.

Optionally, the way of determining the shape-context-histogram features of the predetermined source-material region images comprises:

acquiring the source-material region images;

by using an alpha channel, extracting outlines of the source-material region images;

sampling the outlines of the source-material region images, to determine a plurality of critical points of the source-material region images; and

inputting the plurality of critical points of the source-material region images into a predetermined shape-context-vector extractor, and performing shape-context-histogram-feature extraction, to obtain the shape-context-histogram features of the predetermined source-material region images.

Optionally, the source material is a cartoon source material, and the fifth processing module 305 is particularly configured for splicing cartoon-source-material region images that match with each of the regions of the original image, to obtain a cartoon image corresponding to the original image.

The embodiment of the present application has at least the following advantageous effects:

the embodiment of the present application, by acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image, realizes the quick matching of the regions of the original image with the corresponding source-material region images, and, by splicing the matched source-material region images, enables the obtained target image and the original image to be very similar both as a whole and in the regions, which results in the effect of beautification, and significantly improves the user experience.

The contents of the image processing apparatus according to the embodiment of the present application that are not described in detail may refer to the image processing method according to the first embodiment. The advantageous effects that the image processing apparatus according to the embodiment of the present application can reach are the same as those of the image processing method according to the first embodiment, and are not discussed here further.

### The Third Embodiment

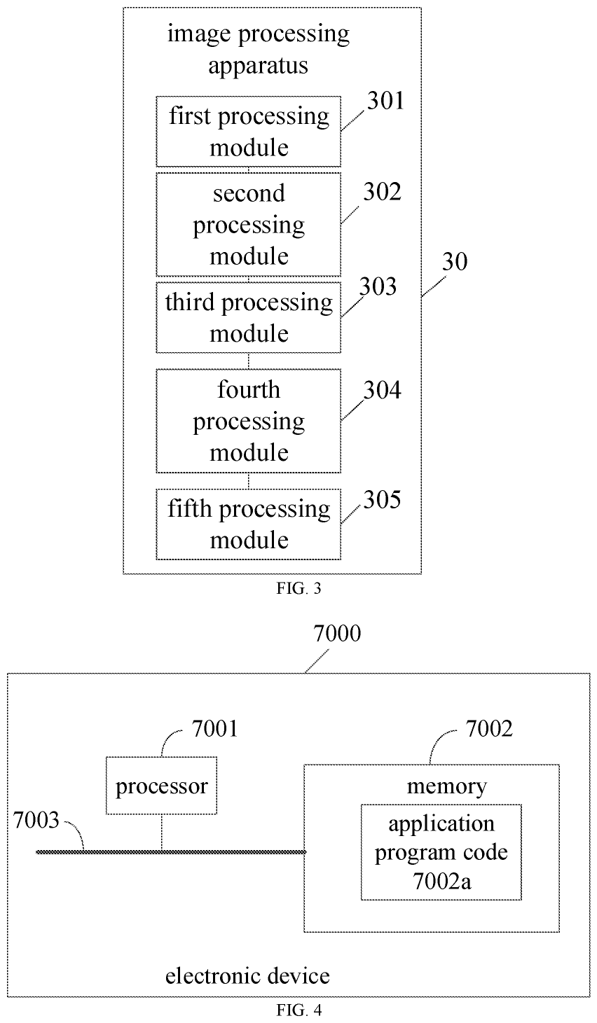

On the basis of the same inventive concept, an embodiment of the present application further provides an electronic device. A schematic structural diagram of the electronic device is shown in FIG. 4. The electronic device 7000 comprises at least one processor 7001, a memory 7002 and a bus 7003. The at least one processor 7001 is electrically connected to the memory 7002. The memory 7002 is configured for storing at least one computer-executable instruction. The processor 7001 is configured for executing the at least one computer-executable instruction, so as to implement the steps of any one image processing method according to any one of the embodiments according to the first embodiment of the present application or any one alternative embodiment.

Optionally, the processor 7001 may be an FPGA (Field-Programmable Gate Array) or another device having the capacity of logical processing, for example, an MCU (Microcontroller Unit) or a CPU (Central Process Unit).

The embodiment of the present application has at least the following advantageous effects:

the embodiment of the present application, by acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image, realizes the quick matching of the regions of the original image with the corresponding source-material region images, and, by splicing the matched source-material region images, enables the obtained target image and the original image to be very similar both as a whole and in the regions, which results in the effect of beautification, and significantly improves the user experience.

### The Fourth Embodiment

On the basis of the same inventive concept, an embodiment of the present application further provides a computer-readable storage medium, for example, the memory 7002 in FIG. 4, wherein the memory 7002 stores a computer program 7002a, and the computer program is configured for, when executed by a processor, implement the steps of any one of the embodiments of the first embodiment of the present application or any one image processing method.

The computer-readable storage medium according to the embodiment of the present application includes but is not limited to any type of disks (including a floppy disk, a hard disk, an optical disk, a CD-ROM and a magneto-optical disk), a ROM (Read-Only Memory), a RAM (Random Access Memory), an EPROM (Erasable Programmable Read-Only Memory), an EEPROM (Electrically Erasable Programmable Read-Only Memory), a flash memory, a magnetic card or a light-ray card. In other words, the readable storage medium includes any media that a device (for example, a computer) uses to store or transmit information in a readable form.

The embodiment of the present application has at least the following advantageous effects:

the embodiment of the present application, by acquiring a plurality of critical points of regions of an original image, wherein the regions correspond to different body parts in a portrait; according to the plurality of critical points of the regions, determining shape-context-histogram features of the regions of the original image; according to the shape-context-histogram features of the regions of the original image and shape-context-histogram features of predetermined source-material region images of corresponding regions, determining a plurality of cost matrixes for the regions; according to the plurality of cost matrixes for the regions, screening source-material region images that match with each of the regions of the original image from the source-material region images; and splicing the source-material region images that match with each of the regions of the original image, to obtain a target image corresponding to the original image, realizes the quick matching of the regions of the original image with the corresponding source-material region images, and, by splicing the matched source-material region images, enables the obtained target image and the original image to be very similar both as a whole and in the regions, which results in the effect of beautification, and significantly improves the user experience.

A person skilled in the art can understand that computer program instructions may be used to implement each of the blocks of those structural diagrams and/or block diagrams and/or flow charts and the combinations of the blocks of those structural diagrams and/or block diagrams and/or flow charts. A person skilled in the art can understand that those computer program instructions may be provided to and executed by a generic computer, a special-purpose computer or another processor that can program a data processing method, so as to implement the solutions specified in one or more blocks of the structural diagrams and/or block diagrams and/or flow charts according to the present application by using the computers or the another processor that can program a data processing method.

A person skilled in the art can understand that the steps, measures and solutions in the various operations, methods and processes that have been discussed in the present application may be substituted, modified, combined or deleted. Further, the other steps, measures and solutions in the various operations, methods and processes that have been discussed in the present application may be substituted, modified, rearranged, decomposed, combined or deleted. Further, the steps, measures and solutions in the various operations, methods and processes disclosed in the present application in the prior art may be substituted, modified, rearranged, decomposed, combined or deleted.

The above-described are merely some of the embodiments of the present application. It should be noted that a person skilled in the art may make various improvements without departing from the principle of the present application, wherein those improvements should be considered as falling within the protection scope of the present application.

1. An image processing method, wherein the method comprises:
acquiring a plurality of critical points of regions of an original image, wherein the regions correspond to different body parts in a portrait;
according to the plurality of critical points of the regions, determining shape-context-histogram features of the regions of the original image;
according to the shape-context-histogram features of the regions of the original image and shape-context-histogram features of predetermined source-material region images of corresponding regions, determining a plurality of cost matrixes for the regions;
according to the plurality of cost matrixes for the regions, screening source-material region images that match with each of the regions of the original image from the source-material region images; and
splicing the source-material region images that match with each of the regions of the original image, to obtain a target image corresponding to the original image.

2. The method according to claim 1, wherein when the regions of the original image are face-organ regions of the original image, the step of acquiring the plurality of critical points of the regions of the original image comprises:
acquiring a plurality of dense critical points of the original image;
classifying the plurality of dense critical points of the original image, to obtain a plurality of dense critical points of each of the face-organ regions of the original image; and
sampling the plurality of dense critical points of each of the face-organ regions of the original image, to obtain a plurality of critical points of each of the face-organ regions of the original image obtained after the sampling.

3. The method according to claim 1, wherein when one of the regions of the original image is a hair region of the original image, the step of acquiring the plurality of critical points of the regions of the original image comprises:
acquiring a grayscale map of the hair region of the original image;
according to the grayscale map of the hair region of the original image, determining an outline of the hair region of the original image; and
sampling the outline of the hair region of the original image, to obtain a plurality of regional critical points of the hair region of the original image.

4. The method according to claim 2, wherein the step of, according to the plurality of critical points of the regions, determining the shape-context-histogram features of the regions of the original image comprises:
inputting the plurality of critical points of each of the face-organ regions of the original image and a plurality of regional critical points of a hair region of the original image into a predetermined shape-context-vector extractor, and performing shape-context-histogram-feature extraction, to obtain shape-context-histogram features of each of the face-organ regions of the original image and shape-context-histogram features of the hair region of the original image.

5. The method according to claim 4, wherein the step of, according to the shape-context-histogram features of the regions of the original image and the shape-context-histogram features of the predetermined source-material region images of the corresponding regions, determining a plurality of cost matrixes for the regions comprises:
according to the shape-context-histogram features of each of the face-organ regions of the original image, the shape-context-histogram features of the hair region of the original image and the shape-context-histogram features of the predetermined source-material region images of the corresponding regions, by using Chi-square-distance calculation, obtaining a plurality of cost matrixes for each of the face-organ regions of the original image and a plurality of cost matrixes for the hair region of the original image, wherein the predetermined source-material region images include face-organ source-material images and a hair source-material image, and each of elements of the cost matrixes characterizes a Chi-square distance between one of the critical points of the regions and one of the critical points of one of the source-material region images of the corresponding regions.

6. The method according to claim 5, wherein the step of, according to a plurality of cost matrixes for the regions, screening source-material region images that match with each of the regions from the source-material region images comprises:
according to N cost matrixes corresponding to any one of the regions of the original image, matching each of the critical points of the any one of the regions with a critical point in a predetermined any one of the source-material region images that has a minimum Chi-square distance to the each of the critical points, summing the minimum Chi-square distances corresponding to all of the critical points of the any one of the regions as a cost value between the any one of the regions and the any one of the source-material region images, to obtain N cost values between the any one of the regions and predetermined N source-material region images, wherein N is a positive integer, and using a source-material region image corresponding to a minimum cost value among the N cost values as the source-material region image that matches with the any one of the regions.

7. The method according to claim 1, wherein the way of determining the shape-context-histogram features of the predetermined source-material region images comprises:
acquiring the source-material region images;
by using an alpha channel, extracting outlines of the source-material region images;
sampling the outlines of the source-material region images, to determine a plurality of critical points of the source-material region images; and
inputting the plurality of critical points of the source-material region images into a predetermined shape-context-vector extractor, and performing shape-context-histogram-feature extraction, to obtain the shape-context-histogram features of the predetermined source-material region images.

8. The method according to claim 1, wherein the source material is a cartoon source material, and the step of splicing the source-material region images that match with each of the regions of the original image, to obtain the target image corresponding to the original image comprises:
splicing cartoon-source-material region images that match with each of the regions of the original image, to obtain a cartoon image corresponding to the original image.

9. (canceled)

10. An electronic device, wherein the electronic device comprises a processor and a memory;
the memory is configured for storing a computer program; and
the processor is configured for, by invoking the computer program, implementing the image processing method according to claim 1.

11. A computer-readable storage medium, wherein the computer-readable storage medium stores a computer program, and the computer program is configured for, when executed by a processor, implementing the image processing method according to claim 1.

12. A computer program, wherein the computer program comprises a computer-readable code, and when the computer-readable code is executed on a calculating and processing device, the computer-readable code causes the calculating and processing device to implement the image processing method according to claim 1.

13. The electronic device according to claim 10, wherein when the regions of the original image are face-organ regions of the original image, the step of acquiring the plurality of critical points of the regions of the original image comprises:
acquiring a plurality of dense critical points of the original image;
classifying the plurality of dense critical points of the original image, to obtain a plurality of dense critical points of each of the face-organ regions of the original image; and
sampling the plurality of dense critical points of each of the face-organ regions of the original image, to obtain a plurality of critical points of each of the face-organ regions of the original image obtained after the sampling.

14. The electronic device according to claim 10, wherein when one of the regions of the original image is a hair region of the original image, the step of acquiring the plurality of critical points of the regions of the original image comprises:
acquiring a grayscale map of the hair region of the original image;
according to the grayscale map of the hair region of the original image, determining an outline of the hair region of the original image; and
sampling the outline of the hair region of the original image, to obtain a plurality of regional critical points of the hair region of the original image.

15. The electronic device according to claim 11, wherein the step of, according to the plurality of critical points of the regions, determining the shape-context-histogram features of the regions of the original image comprises:
inputting the plurality of critical points of each of the face-organ regions of the original image and a plurality of regional critical points of a hair region of the original image into a predetermined shape-context-vector extractor, and performing shape-context-histogram-feature extraction, to obtain shape-context-histogram features of each of the face-organ regions of the original image and shape-context-histogram features of the hair region of the original image.

16. The electronic device according to claim 13, wherein the step of, according to the shape-context-histogram features of the regions of the original image and the shape-context-histogram features of the predetermined source-material region images of the corresponding regions, determining a plurality of cost matrixes for the regions comprises:
according to the shape-context-histogram features of each of the face-organ regions of the original image, the shape-context-histogram features of the hair region of the original image and the shape-context-histogram features of the predetermined source-material region images of the corresponding regions, by using Chi-square-distance calculation, obtaining a plurality of cost matrixes for each of the face-organ regions of the original image and a plurality of cost matrixes for the hair region of the original image, wherein the predetermined source-material region images include face-organ source-material images and a hair source-material image, and each of elements of the cost matrixes characterizes a Chi-square distance between one of the critical points of the regions and one of the critical points of one of the source-material region images of the corresponding regions.

17. The electronic device according to claim 14, wherein the step of, according to a plurality of cost matrixes for the regions, screening source-material region images that match with each of the regions from the source-material region images comprises:
according to N cost matrixes corresponding to any one of the regions of the original image, matching each of the critical points of the any one of the regions with a critical point in a predetermined any one of the source-material region images that has a minimum Chi-square distance to the each of the critical points, summing the minimum Chi-square distances corresponding to all of the critical points of the any one of the regions as a cost value between the any one of the regions and the any one of the source-material region images, to obtain N cost values between the any one of the regions and predetermined N source-material region images, wherein N is a positive integer, and using a source-material region image corresponding to a minimum cost value among the N cost values as the source-material region image that matches with the any one of the regions.

18. The electronic device according to claim 10, wherein the way of determining the shape-context-histogram features of the predetermined source-material region images comprises:
acquiring the source-material region images;
by using an alpha channel, extracting outlines of the source-material region images;
sampling the outlines of the source-material region images, to determine a plurality of critical points of the source-material region images; and
inputting the plurality of critical points of the source-material region images into a predetermined shape-context-vector extractor, and performing shape-context-histogram-feature extraction, to obtain the shape-context-histogram features of the predetermined source-material region images.

19. The electronic device according to claim 10, wherein the source material is a cartoon source material, and the step of splicing the source-material region images that match with each of the regions of the original image, to obtain the target image corresponding to the original image comprises:
splicing cartoon-source-material region images that match with each of the regions of the original image, to obtain a cartoon image corresponding to the original image.
